(19) United States
(12) Patent Application Publication
(10) Pub. No.: US 2026/0021428 A1
(43) Pub. Date: Jan. 22, 2026

(54) Oil Filter

(71) Applicant: Illinois Tool Works Inc., Glenview, IL (US)

(72) Inventors: Franck Couty, Senlis (FR); Sylvain Martineau, Vineuil saint Firmin (FR); Guillaume Lefebvre, Chazay d'azergues (FR); Etienne Piot, Chamant (FR)

(21) Appl. No.: 19/272,232

(22) Filed: Jul. 17, 2025

(30) Foreign Application Priority Data
Jul. 19, 2024 (EP) 24189837.8
Jun. 23, 2025 (DE) 10 2025 124 148.1

(51) Int. Cl. B01D 29/54; B01D 29/15; B01D 29/23; B01D 35/147

(52) U.S. Cl. CPC B01D 29/54; B01D 29/15; B01D 29/23; B01D 35/1475; B01D 2201/298

(57) ABSTRACT

An oil filter that includes an outer filter and an inner filter. The inner filter is placed inside the outer filter, creating a space between them. This space is connected to an outlet. The inner filter also has an inlet that allows fluid to flow into its interior.

### RELATED APPLICATIONS

The present application claims the benefit of European Patent Application No. 24189837.8, filed on Jul. 19, 2024, and German Patent Application No. 10 2025 124 148.1, filed on Jun. 23, 2025, each titled “Oil Filter,” the contents of which are hereby incorporated by reference.

### BACKGROUND

The application relates to an oil filter.

Electric vehicles often comprise one or more oil filters which filter oils used in lubrication and/or cooling of motors, gearing and the like. Oil filters remove wear debris from the circulating oil thereby reducing premature wear of these moving parts.

As the oil is passed through a filter mesh a pressure drop in the flow of oil is inevitable across the filter. The reduction in pressure is undesirable as it reduces fluid flow and reduces the available oil, or rate of change over of oil, for lubrication/cooling.

In order to reduce strain on the system and ensure an adequate flow of oil is maintained it is desirable to reduce this pressure drop. This is normally achieved by increasing the surface area of a filter, so more oil can pass through a filter in a given time period. This results in the use of larger, bulky, filters. However, the surface area of such oil filters is constrained by space requirements, therefore filters can only be increased in size so much. Filters must also remain removable and replaceable during routine service.

### SUMMARY

The present disclosure relates generally to an oil filter, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1 illustrates an oil filter.

FIGS. 2a and 2b illustrate, respectively, a bottom perspective view of an oil filter and a top perspective view of an oil filter.

FIG. 3 illustrates a cross-sectional view of an oil filter.

FIG. 4 illustrates an alternative oil filter.

FIG. 5 illustrates a cross section of an alternative oil filter.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

This application relates to oil filters. In this application an oil filter which has parallel filtering paths is disclosed. Two concentric, or otherwise nested, filtering cylinders (inner and outer filters) define an oil path in-between (i.e. A cavity). A fluid outlet is provided connecting the cavity to the exterior of the filter. It is noted that the term “filtering cylinders” should not be considered as limitative, or even descriptive of the shape of the nested filters. Any suitable polyhedral shape may be described by the nested filters. The filters may describe different shapes relative to one another.

There is no “overall external inlet” as such, the entire filter is submerged into a bath of pre-filtered oil, the “overall external inlet”, as such are the filters. Although, having an overall external fluid inlet is not precluded. “External inlet” here means an inlet provided to allow the flow of fluid external to the oil filter into the oil filter.

According to the disclosure there is provided an oil filter comprising an outer filter and an inner filter. The inner filter being located inside the outer filter and defining a cavity therebetween. The cavity fluidly connecting to an outlet, wherein the inner filter further comprises an inlet in fluid communication to an interior of the inner filter. The oil filter advantageously provided two independent fluid flow paths thereby providing increased filtering capacity compared other similarly sized oil filters. Furthermore, the oil filter may continue to function even if one of the two independent fluid flow paths becomes occluded.

Suitably there are two flow paths from an outside the oil filter to the outlet. Optionally a first of the two flow paths is from the outside of the oil filter, through the outer filter, into the cavity, and out of the outlet. Further optionally, a second of the two flow paths is from the outside to an interior of the inner filter, through the inner filter, into the cavity, and out of the outlet. In this way the two flow paths do not meet until the fluid enters the cavity.

Preferably, the outer filter and inner filter are attached to a cap, and arranged such that an oil flow path is provided to the inner filter via the cap. As such the inner filter is only accessible via a route that is independent from fluid accessing the outer filter.

Appositely, the cap is detachable from either or both of the inner filter or the outer filter, which allows the cap to be retained and reused if the filter is replaced.

Suitably, the cap is provided with an interface (202), thereby allowing a tool to act upon the cap to assist in removal and/or fitment of the oil filter via the cap.

Preferably, the cap provides a fixation means to attach the oil filter to a vehicle in order to hold the oil filter secure upon the vehicle.

Appositely, the cap is removably attached to the inner filter and the outer filter.

Suitably, the inner filter is nested within the outer filter to minimize the size of the oil filter.

Preferably, the inner filter and/or the outer filter describe a cylindrical shape, so they may easily nest within one another. A corrugated arrangement may also be used to maximize surface area.

Appositely, the inner filter and/or the outer filter comprise a frame to support a filter matrix, mesh, or fabric.

Suitably, the cavity is only accessible by a fluid that has passed through either the inner filter or the outer filter.

Preferably, the outlet is provided on the outer filter.

Appositely, the outlet comprises a spigot to attach a pipe or other fluid conduit to transport filtered fluids away from the oil filter. Suitably, the outlet may further comprises a seal.

Preferably, the oil filter further comprises a pressure relief valve to mitigate the risk of an over-pressure event rupturing the oil filter. Optionally, the pressure relief valve is provided in the inner filter. Suitably, the pressure relief valve may be distributed within the cavity and fluidly connected between the inner filter and the outlet.

Appositely, the pressure relief valve is at least partially formed from the inner filter and/or the outer filter, thereby minimizing additional material being required.

Preferably, the outer filter is arranged to allow oil external to the oil filter to flow into the cavity and/or the inner filter is arranged to allow oil in the center of the oil filter to flow in the direction of the outer filter.

Suitably, either the inner filter or the outer filter comprise a platform arranged to support the pressure relief valve.

With reference to the figures (it is noted that the filter mesh is not shown in the figures to not unnecessarily obscure the figures, the optional frame provided to support the mesh or filter material is shown), the inner filter comprises an inner filter inlet in fluid communication to an interior of the inner filter, in order to allow fluid access to the inner filter for filtration. There the inner and outer filters are arranged concentric cylinders, for example, the inlet to the inner filter may simply be an open end of the cylinder forming the inner filter. There are therefore two flow paths for liquids through the oil filter 102.

With respect to the outer filter 106, the liquid traverses an outer filter wall to the cavity 104 and from the cavity 104 the liquid may pass out of the outlet 112. With respect to the inner filter 108, the liquid passes through the inner filter inlet where the liquid is then adjacent an inner filter wall, the liquid passes through the inner filter wall to the cavity 104, where the liquid may then pass out of the outlet 112.

A fluid flow path is provided to allow oil to flow through both the inner filter and the outer filter simultaneously from the surroundings. Once through the filters, the oil then leaves the filter via the outlet. Oil can therefore either flow through the outer cylinder wall to the outlet or through the inner cylinder wall to the outlet. A flow path is provided to allow oil to flow to the inner filter, bypassing the outer filter. Therefore the oil filter is provided with parallel filtering paths. The use of nested inner and outer filters increase the filtering surface area and allow more oil to pass through the filter in a given time, thereby reducing the pressure drop observed for a similarly sized single oil filter. The oil filter is also minimized in dimensions. The oil filter also has a pressure relief valve for bypassing the oil path through the oil filter in case of overpressure.

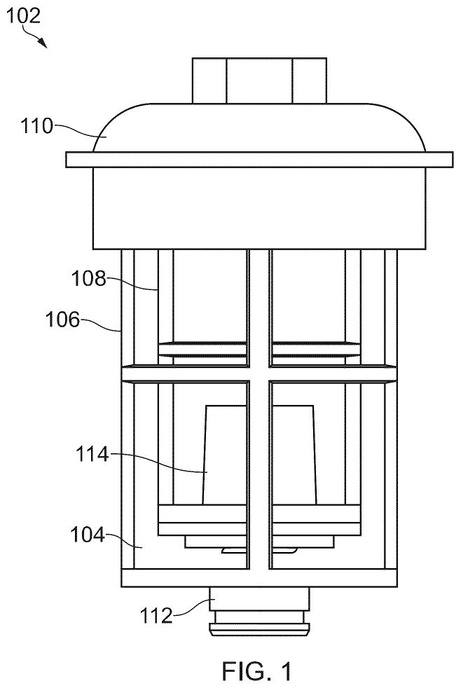

With reference to FIGS. 1, 2a, 2b, and 3 there is shown an oil filter 102 for use in an electric vehicle. The oil filter comprises an outer filter 106 and an inner filter 108. The inner filter is located inside the outer filter (i.e. The inner filter is nested within the outer filter). The two filters are spaced apart, so a cavity 104 is defined between the inner filter and the outer filter. The cavity may only be accessed by a fluid that has passed through either the inner filter or the outer filter. As such a seal, wall, or other barrier to the fluid may be present to bridge any gap between the inner filter and the outer filter when nested. The cavity is fluidly connected to an outlet 112 in order to allow oil which has been filtered by either the inner filter or the outer filter to pass out of the oil filter and be directed to other systems within the vehicle. Where the oil filters are formed from a flexible material (such as a fabric or mesh) a supporting cage may be included for each of the inner filters and the outer filter to ensure each filter maintains its shape.

The material of the filters may be selected to remove debris of a predefined size, e.g. The filter material may be capable of preventing micro sized particles from passing across the filter.

The outer filter and inner filter may be attached to a cap 110 or the filters may be independent of cap. Where a cap is used, the inner and outer filters are arranged such that an oil flow path is provided about the outer filter and to the inner filter via the cap, such as through a cap aperture. For example, the cap may directly attach to the inner filter and then the outer filter may be further attached to the inner filter. A fluid flow path may be provided from the exterior of the oil filter (bounded by the outer filter) into the interior of the oil filter which is bounded by the inner filter. One or more ribs may be provided to connect the cap to the inner filter.

The cap, where present, provides a fixation means to attach and/or mount the oil filter to a suitable aperture in the vehicle. The cap may comprise a thread, bayonet fixing, or other suitable coupling means which is complementary to a like coupling means of the vehicle. Additional sealing, (for example an “O” ring) may be provided between the cap and the vehicle to prevent oil from escaping through the aperture.

The cap may be permanently or removably attached to the inner filter and/or outer filter. A snap-fit may be provided between the components. The cap, inner filter and outer filter may be delivered as a single part.

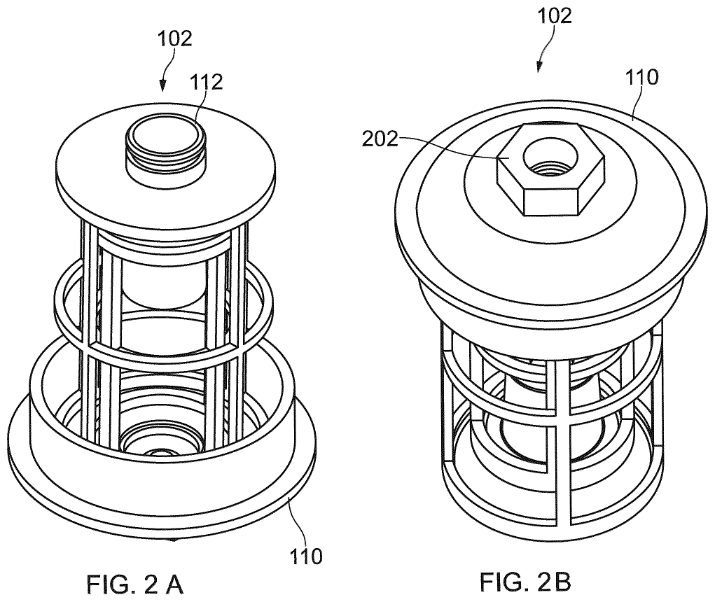

As shown in FIGS. 2a and 2b the cap may be provided with an interface 202 to accept a tool to allow the oil filter to be removed, by application of the tool to the interface, although it will be understood that this interface is optional or may take any other suitable form to allow the oil filter to be removed by the appropriate tool (e.g. Spanner, hex key, screw driver).

The outlet 112 may be provided on the outer filter, the outlet may comprise a spigot that allows a tube or other fluid conduit to be connected to the outlet to transport filtered oil to other systems of the vehicle. The outlet may be provided with a suitable seal (for example an “O” ring) to ensure oil does not intentionally bypass the oil filter, and that the oil can only pass through the oil filter by the inner filter, outer filter, or by a pressure relief valve.

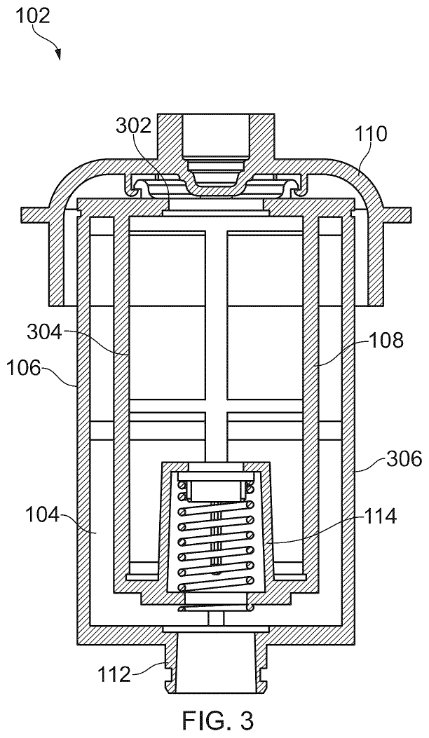

A pressure relief valve 114 is also provided, as shown in FIG. 3. The pressure relief valve is located inside the oil filter, although the location within the oil filter may vary. As per FIG. 3 the pressure relief valve is part of the inner filter, although alternative configurations are available. The pressure relief valve shown in FIG. 3 bypasses the oil filter and allows fluid to flow directly from external the oil filter to the outlet 112. A biasing means closes an aperture within the inner filter, which, if opened, provides a direct fluid path to the outlet. The biasing means can be any suitable, provided the biasing means may be overpowered (and therefore opening the pressure relief valve) by an increase in oil pressure over a threshold value. The biasing means may be a spring for example.

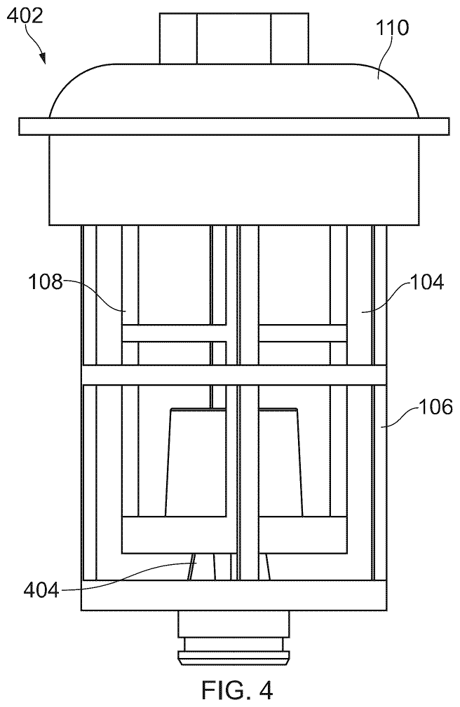

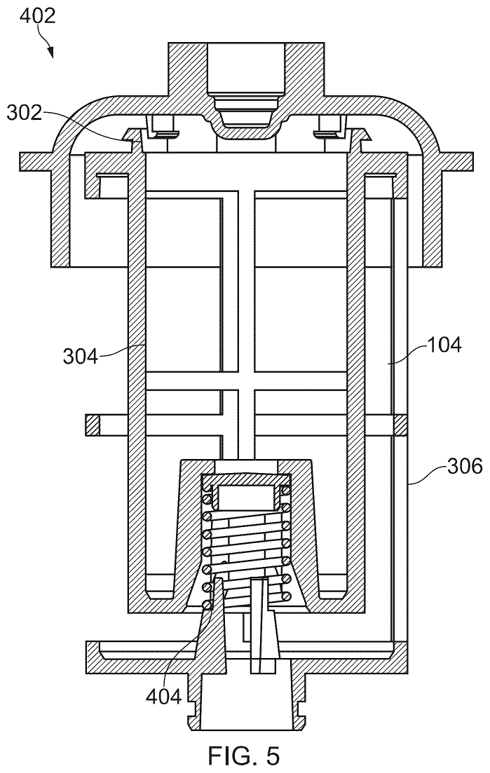

As shown in FIG. 4 and FIG. 5 there is provided an alternative oil filter 402. Like elements are provided with similar reference numerals as the first oil filter 102 disclosed herein to avoid unnecessary duplication. The oil filter 402 differs from the oil filter 102 of FIG. 1 in that the pressure relief valve 404 is distributed within the cavity 104 and fluidly connected between the inner filter and the outlet. The inner filter and the outer filter therefore both contribute to the structure of the pressure relief valve 404. The pressure relief valve is therefore formed at least in part from the frames forming the inner filter and the outer filter. This provides a platform for a support structure for the biasing means (e.g. stepped legs). The support structure provides a locating surface for the biasing means and prevents the biasing means becoming dislodged as well as a solid surface upon which the biasing means can be compressed against or otherwise overcome. This configuration requires less material and parts.

The oil filters disclosed herein may be formed of any suitable material, which is typically (but not exclusively) plastic.

It will be appreciated by persons skilled in the art that the above detailed examples have been described by way of example only and not in any limitative sense, and that various alterations and modifications are possible without departing from the scope of the disclosure as defined by the appended claims. Various modifications to the detailed examples described above are possible.

Through the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

While the present method and/or system have been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. An oil filter (102, 402) comprising:
an outer filter (106); and
an inner filter (108),
wherein the inner filter is located inside the outer filter and defines a cavity (104) therebetween, the cavity fluidly connected to an outlet (112), and
wherein the inner filter further comprises an inlet in fluid communication to an interior of the inner filter.

2. The oil filter of claim 1, further comprising two flow paths from an outside the oil filter to the outlet.

3. The oil filter of claim 1, wherein the outer filter and inner filter are attached to a cap (110), and arranged such that an oil flow path is provided to the inner filter via the cap.

4. The oil filter of claim 1, wherein the inner filter is nested within the outer filter and wherein:
the inner filter and/or the outer filter describe a cylindrical shape, and/or
the inner filter and/or the outer filter comprise a frame, and/or
the cavity is only accessible by a fluid that has passed through either the inner filter or the outer filter.

5. The oil filter of claim 1, wherein the outlet is provided on the outer filter, and wherein:
the outlet comprises a spigot, and/or
the outlet further comprises a seal.

6. The oil filter of claim 1,
wherein the oil filter further comprises a pressure relief valve (114, 404), and optionally wherein the pressure relief valve is provided in the inner filter, and/or
the pressure relief valve is distributed within the cavity and fluidly connected between the inner filter and the outlet, and/or
wherein the pressure relief valve is at least partially formed from the inner filter and/or the outer filter.

7. The oil filter of claim 1, wherein the outlet is provided on the outer filter.

8. The oil filter of claim 1, wherein the outer filter is arranged to allow oil external to the oil filter to flow into the cavity.

9. The oil filter of claim 1, wherein the inner filter is arranged to allow oil in the center of the oil filter to flow in the direction of the outer filter.

10. The oil filter of claim 1, wherein either the inner filter or the outer filter comprises a platform arranged to support the pressure relief valve.

11. The oil filter of claim 2, wherein a first of the two flow paths is from the outside of the oil filter, through the outer filter, into the cavity, and out of the outlet.

12. The oil filter of claim 11, wherein a second of the two flow paths is from the outside to an interior of the inner filter, through the inner filter, into the cavity, and out of the outlet.

13. The oil filter of claim 3,
wherein the cap is detachable from either or both of the inner filter or the outer filter, and/or
wherein the cap is provided with an interface (202), and/or
wherein the cap provides a fixation means to attach the oil filter to a vehicle and/or
wherein the cap is removably attached to the inner filter and the outer filter.
